(19) United States
(12) Patent Application Publication
(10) Pub. No.: US 2011/0089165 A1
(43) Pub. Date: Apr. 21, 2011

(54) INDUCTIVE HEATER FOR DENTAL TECHNIQUE AND OPERATION METHOD THEREOF

(76) Inventor: Jong Dae Cha, Daegu-si (KR)

(21) Appl. No.: 12/936,897

(22) PCT Filed: Jul. 24, 2009
(86) PCT No.: PCT/KR2009/004140

§ 371 Date: Oct. 7, 2010

(30) Foreign Application Priority Data
Jul. 29, 2008 (KR) 10-2008-0073973
Sep. 29, 2008 (KR) 10-2008-0095530

(51) Int. Cl. H05B 6/10

(52) U.S. Cl. 219/635

(57) ABSTRACT

The present invention discloses an inductive heater for a dental technique and a method for operating the same. The inductive heater for a dental technique according to the present invention comprises: a bobbin with a chisel insertion hole connected to inner space at one end and a jointing unit protruded outwardly at the other end; an induction coil wound in the bobbin; an upper case comprising a mounting hole to which the bobbin is inserted and a bobbin fixing protrusion which is bolt-jointed to the jointing unit of the bobbin inserted inwardly through the mounting hole; and a lower case which is joined to the lower part of the upper case. The inductive heater for a dental technique significantly improves productivity of assembly due to a simple jointing structure of the bobbin. Also, the inductive heater is devised for worker's health and work environment by rapidly discharging wax vapor. In addition, usability is enhanced because the electric current control action for supplying electric current to the induction coil is accurately performed only during use of the inductive heater without operation of an on/off switch by a worker.

### TECHNICAL FIELD

The present invention relates to an inductive heater for dental technique, in more detail, an inductive heater for dental technique that can achieve convenience and accuracy of work by stably heating a chisel at a predetermined temperature within a short time in the dental technology that accurately processes a predetermined was pattern with a chisel.

### BACKGROUND ART

In general, the dental technology is a special medical field associated with the dental surgery, which implies an industrial field that manufactures and repairs dental devices for recovering functions of damaged tissues of parts around the mouth, such as teeth, tissues around the teeth, the maxilloface, correcting abnormal jaws, and correcting the teeth.

Meanwhile, since common dental devices are manufactured in consideration of various individual features, including the oral structure of the users, they cannot substantially manufactured in large quantities by machines, such that most of them are manually manufactured by experts, such as dental technicians.

For example, a process of manufacturing an artificial tooth, using a lost was process, is briefly described.

First, a pattern of a tooth is made by a tooth impression compound, such as alginate, a plaster cast is formed by pouring liquid plaster, the plaster cast is accurately processed into a wax model of a wax pattern, and then a sprue pin is attached.

Thereafter, the wax model with the sprue pin is fixed to a crucible former (sprue base), covered with a casting ring and then hardened by injecting an investment, and the hardened model formed by investing the wax model is put into a furnace to melt and remove the wax model, thereby forming a cavity having the shape of the tooth in the hardened model. Finally, a molten alloy, which is a prosthetic material, is injected and hardened in the cavity of the hardened model and polished therein, thereby completing a partial artificial tooth.

In particular, the manufacturing of the wax model in the process completely depends on accurate process of the experts, such as dental technicians, and the dental technicians works with specific chisels.

The dental technician work while frequently heating the chisels with a torch or an alcohol lamp for accurate process, which is very trouble and it is substantially impossible to uniformly heating the chisels at desired temperature, and there is a danger in safety.

An inductive heater using eddy current has been proposed in recent years to solve the problem. However, since it is complicated to fasten a bobbin with an induction coil wound in the inductive heater of the related art, workability is deteriorated, and it is difficult to appropriately discharge harmful wax vapor produced by heating the was.

On the other hand, the inductive heater of the related art is sometimes equipped with a sensor coil for sensing a chisel on the outer circumference of the end of the bobbin to automatically supply/stop current for the induction coil. However, since the diameter of the chisel is at most about 1 mm, the sensor coil fails to sense the chisel and current is not supplied to the induction coil, which interferes with the work instead.

### DISCLOSURE

### Technical Problem

The present invention has been made to solve the problems and it is an object of the present invention to reduce a lot of cost and efforts for manufacturing and assembling by simplifying the fastening structure of a bobbin of an inductive heater, and improve a work environment and the worker's health by rapidly discharging harmful vapor.

Further, it is another object of the present invention to provide an inductive heater that can stably supply current to an induction coil when being used and stops the current when being not used, even if a worker does not operates the on/off switch.

### Technical Solution

In order to solve the problems, the present invention provides an inductive heater for dental technique, which includes: a bobbin having a chisel insertion hole open at one end and having a fastening portion protruding outward at the other end; an induction coil wound around the bobbin; an upper case having a mounting hole where the bobbin is inserted, and a bobbing fixing protrusion thread-fastened to the fastening portion of the bobbin; and a lower case connected to the bottom of the upper case.

The end of the fastening portion of the bobbin and the end of the bobbin fixing protrusion are in surface contact with each other, when the bobbin is inserted in the mounting hole.

Further, the present invention provides an inductive heater for dental technique, which includes: a bobbin having a chisel insertion hole open at one end, and fitting protrusions with tooth-shaped concave-convexo portion and anti-rotation protrusions on the outer circumference; an induction coil wound on the bobbin; an upper case having a mounting hole where the bobbin is inserted and insertion groove formed around the mounting hole to fit the anti-rotation protrusions; and a lower case connected to the bottom of the upper case, in which when the bobbin is inserted in the mounting hole, the concave-convexo portions of the fitting protrusions are engaged with the inner edges of the mounting hole, such that the bobbin is fixed to the upper case.

The fitting protrusion has a triangular bridge shape and only the front end of the fitting protrusion is connected to the outer side of the bobbin.

An optical sensor that senses worker's hands approaching is disposed on the outer side of the upper case or at the front end of the bobbin.

### ADVANTAGEOUS EFFECT

According to an inductive heater for dental technique of the present invention, it is possible to considerably improve assembly productivity by a simple fastening structure of a bobbin. Further, it is possible to improve the workers' health and working environment by rapidly discharging wax vapor.

Further, it is possible to accurately control current to supply current to an induction coil only when the inductive heater is used, even if a worker does not operate an on/off switch, such that it is possible to work more conveniently.

### BRIEF DESCRIPTION OF DRAWINGS

FIG. 1 is a perspective view of an inductive heater for dental technology according to a first embodiment of the present invention.

FIG. 2 is a combination cross-sectional view of the inductive heater for dental technology according to the first embodiment of the present invention.

FIG. 3 is an exploded perspective view of the bottom of the inductive heater for dental technology according to the first embodiment of the present invention.

FIG. 4 is an exploded perspective view showing the bottom of a modified embodiment of the first embodiment of the present invention.

FIG. 5 is a combination cross-sectional view showing the bottom of a modified embodiment of the first embodiment of the present invention.

FIG. 6 is a combination cross-sectional view showing when a filter is attached to the bottom of an exhaust fan.

FIG. 7 is a view showing when an optical sensor is attached on the outer side of a bobbin.

FIG. 8 is a view showing an area that the optical sensor shown in FIG. 7 can sense.

FIG. 9 is a view showing when two optical sensors are provided.

FIG. 10 is an exploded perspective view of the bottom of the inductive heater for dental technology according to a second embodiment of the present invention.

FIG. 11 is a combination cross-sectional view of an inductive heater for dental technology according to the second embodiment of the present invention.

### REFERENCE NUMERALS

| 10: Inductive Heater | 12: Upper Case |
|---|---|
| 16: Mounting Hole | 18: Bobbin Fixing Protrusion |
| 20: Fastener Protrusion | 22: Lower Case |
| 26: Filter Cover | 30: Bobbin |
| 32: Chisel Insertion Hole | 34: Flange |
| 36, 38: First and Second Protrusion | |
| 40: Fastening Portion | |
| 42, 24: First and Secodn Exhaust Hole | |
| 60: Printed Circuit Board | |
| 64: Fan Hole | 70: Exhaust Fan |
| 80: Filter | 90: Shield |

B1, B2: First and Second Bolt

### BEST MODE

The present invention is described hereafter in detail with reference to the accompanying drawings.

### First Embodiment

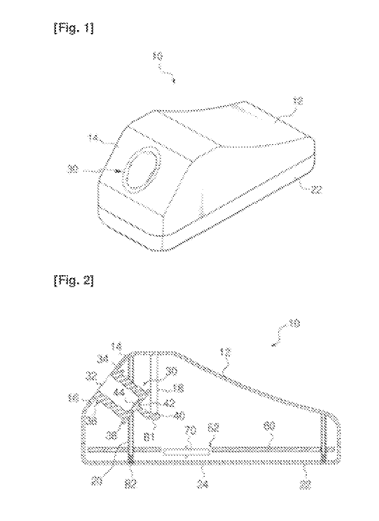

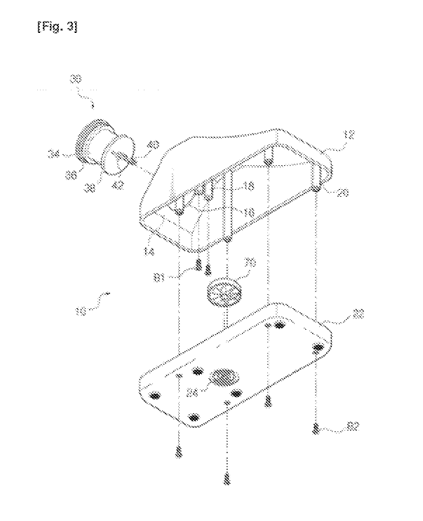

FIG. 1 is a perspective view showing an inductive heater 10 for dental technology (hereafter, briefly referred to as an inductive heater 10) according to a first embodiment of the present invention, FIG. 2 is a combination cross-sectional view, and FIG. 3 is an exploded perspective view of the bottom.

The inductive heater 10 according to the first embodiment includes an upper case 12 and a lower case 22 which define a predetermined internal space, a bobbin 30 disposed through the upper case 12, and a printed circuit board 60 mounted on the lower case 12.

The upper case 12 is formed like a cover with the bottom open and composed of four sides, including the top, in which a slop 14 is formed to face a worker, on one side of the front end of the top for the convenience of the worker. The slope 14 is inclined at an angle of about 30˜45° to the horizon and has a mount hole 16 in which the bobbin 30 is inserted.

Further, a bobbin fixing protrusion 18 for fixing the bobbin 30 and a fastener protrusion 20 protruding for combination with the lower case are formed on the inner side of the upper case 12.

The bobbin 30 has a substantially cylindrical shape with a chisel insertion hole 32 with one end open and an induction coil and/or a sensor coil, which are described below, are wound around the outer circumference. The chisel insertion hole 32 is a portion where a chisel is inserted and heated. Further, one or more fastening portions 40 for fixing the bobbin 30 with respect to the upper case 12 protrudes outward from the other end of the bobbin 30.

In particular, since the bobbin 30 is installed at an angle from the horizon in this embodiment of the present invention, the end of the fastening portion 40 is bent at a predetermined angle in the same direction as the end of the bobbin fixing protrusion 18 in order to fix the end of the fastening portion 40 to the bobbin fixing protrusion 18 in the upper case 12.

Further, a flange 34 having an outer diameter larger than the mounting hole 16 is formed at one end of the bobbin 30 to prevent the bobbin 30 from falling into the upper case in assembly, and first and second protrusion 36, 38 are circumferentially formed on the outer circumference in parallel with the flange 34.

An induction coil (not shown) is wound between the first and second protrusions 36, 38, which are spaced apart from each other. A sensor coil (not shown) that senses access of a chisel by sensing changes in inductive capacity may be wound between the flange 34 and the first protrusion 36. However, the sensor coil may fail to sense a chisel having a very small diameter; therefore, it may be replaced by other types of sensors or used with other types of sensors, which is described below.

It is obvious that the first and second protrusions 36, 38 are larger than the diameter of the mounting hole 16 in order to insert the bobbin 30 in the mounting hole 16.

It is preferable that the bobbin 30 having this structure is made of synthetic resin having high thermal resistance and insulation or ceramic.

When the bobbin 30 is inserted in the mounting hole 16 of the upper case 12, the flange 34 is locked to the edge of the mounting hole 16 and the end of the fastening portion 40 is in close surface contact with the end of the bobbin fixing protrusion 18 of the upper case 12. Therefore, as shown in the figures, it is possible to simply and firmly fix the bobbin 30 to the upper case 12 by fastening the fastening portion 40 to the bobbin fixing protrusion 18 with first bolts B1.

On the other hand, it is possible to bend the end of the bobbin fixing protrusion 18 to the fastening portion 40 without bending the end of the fastening portion 40. In this case, the bending should be appropriately adjusted such that the end of the bobbin fixing protrusion 18 can be in surface contact with the end of the fastening portion 40.

The lower case 22 is fixed to the upper case 12 by a plurality of second bolts B2 inserted in the fastener protrusion 20 of the upper case 12 through the lower case 22.

The printed circuit board 60 is mounted on the lower case 22, and though not shown, a control unit connected with the induction coil and the sensor coil of the bobbin 30 and a power unit supplying power are mounted on the printed circuit board 60. The control unit senses access of the chisel from changes in induction capacity of the sensor coil or senses access of the chisel or the worker by using another sensor, which is described below, and controls the power unit (an external power supply or a battery) to supply current to the induction coil, when sensing the access of the chisel of the worker.

As current is supplied to the induction coil, an induced magnetic field is generated in the chisel insertion hole 32, such that eddy current is induced and heat the metal chisel at high temperature in the chisel insertion hole 32. Thereafter, the worker process the wax model with the chisel heated at appropriate temperature.

Meanwhile, when the inductive heater 10 according to the present invention is used, harmful wax vapor may be produced from the was on the chisel in heating in the chisel insertion hole 32. When the bottom of the chisel insertion hole 32 is closed, the wax vapor is necessarily discharged to the worker.

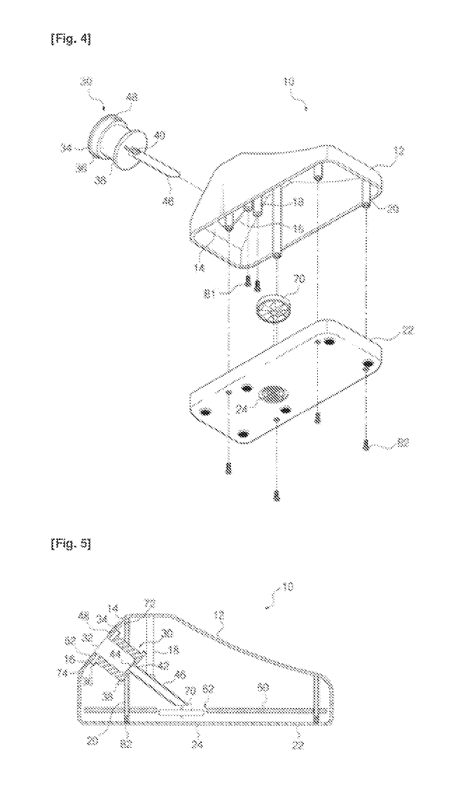

Therefore, it is preferable to forcibly discharge the gas produced in the chisel insertion hole 32 to the opposite side to the worker. For this operation, as shown in the exploded perspective view of the bottom of FIG. 4 and the combination cross-sectional view of FIG. 5, it is preferable to form a first exhaust hole 42 having a predetermined size through the bottom of the chisel insertion hole 32 of the bobbin 30, a second exhaust hole 24 through the upper case 12 or the lower case 22, and dispose an exhaust fan 70 for forcible exhaust around the second exhaust hole 24. Although the second exhaust hole 24 is formed through the lower case 22 in the figures, the position of the second exhaust hole 24 is not limited thereto.

As the exhaust fan 70 rotates, the wax vapor in the chisel insertion hole 32 is forcibly discharged outside through the first and second exhaust holes 42, 24. In this configuration, it is required to form a fan hole 62 at a position corresponding to the second exhaust hole 24 on the printed circuit board 60.

A filter 44 having small mesh structure, such as non-woven fabric or a metal mesh, may be disposed in the first exhaust hole 42 or the bottom of the chisel insertion hole 32 to prevent the wax from leaking.

Further, an exhaust pipe 46 protruding and communicating with the first exhaust hole 42 may be formed at the other end of the bobbin 30 such that the end of the exhaust pipe 46 positioned close to the exhaust fan, as shown in FIGS. 4 and 5, in order to improve exhaust efficiency. According to this configuration, it is possible to discharge the wax vapor as fast as possible because the first exhaust hole 42 is substantially extended close to the exhaust fan 70.

Although it is prevent to the worker from directly inhaling the wax vapor by disposing the exhaust fan 70, the worker may indirectly inhale the wax vapor discharged from the first and second exhaust holes 42, 24. A filter 80 may be disposed between the exhaust fan 70 and the second exhaust hole 24 to prevent the indirect inhalation, as shown in FIG. 6.

A through-hole is formed through the lower case to dispose the filter 80 in the present invention, such that a filter cover 26 is detachably disposed in the through-hole. The second exhaust hole 24 is formed at the filter cover 26 and the filter 80 is disposed inside the filter cover 26.

On the other hand, a shield 90 may be disposed around the exhaust fan 70 and the filter 80 such that internal space and an external space is divided by the shield 90 in order to make smooth exhaust through the second exhaust hole 24. Accordingly, it is possible to more completely preclude the problem due to the wax vapor, because the wax vapor produced in the chisel insertion hole 32 flows into the internal space and then is removed by the filter 80. However, it may be possible to form predetermined holes through the shield 90 for smooth air flow.

Further, the inductive heater 10 of the present invention may be equipped with a cooling fan (not shown) to cool the bobbin 30, or it is possible to cool the inductive heater 10 by using air flow through the exhaust fan 70, without using a specific cooling fan. However, it is preferable to provide a specific cooling fan, other than the exhaust fan 70, in order to improve cooling efficiency.

On the other hand, as described above, the sensor coil is wound between the flange 34 and the first protrusion 36 relatively close to the flange of the bobbin 30 to sense access of a chisel on the basis of changes in inductive capacity; however, it may fail to sense the chisel in accordance with the diameter or the material of the chisel.

In order to overcome the problem, it is possible to replace the sensor coil or dispose optical sensor 72, 74 in the chisel insertion hole 32 to use them with the sensor coil, as shown in FIGS. 4 and 5. In this configuration, the control unit on the printed circuit board 60 supplies current to the induction coil when the optical sensors 72, 74 sense a chisel, and does not supply current when it is not sensed.

When all of the sensor coil and the optical sensors 72, 74 are provided, current may be supplied to the induction coil when a chisel is sensed by any one of them.

When the optical sensors 72, 74 are composed of a light emitting unit 72 and a light receiving unit 72, first and second holes 48, 52 are formed opposite to each other at appropriate positions inside the flange 34 of the bobbin such that the light emitting unit 72 and the light receiving unit 74 of the optical sensors 72, 74 are inserted in the sensor holes. Further, the same effect can be expected even if the optical sensors 72, 74 are disposed at appropriate positions in the chisel insertion hole 32 in accordance with the configuration and function. For example, one or more optical sensors having integrated light emitting unit and light receiving unit may be disposed in the chisel insertion hole 32.

The optical sensors 72, 74 in the bobbin 30 may have difficulty in sensing a chisel with a small diameter; therefore, an optical sensor 76 may be disposed on the outer side of the upper case 12, as shown in FIG. 7, to sense the worker's hands approaching.

In this case, it is preferable to dispose the optical sensor 76 around the mounting hole 16 where the bobbin 30 is inserted. Further, it is preferable that the optical sensor 76 has light emitting unit and a light receiving unit.

The optical sensor 76 may replace the sensor coil and the optical sensors 72, 74, which are described above, or may be used with them. Since the optical sensor 76 is provided to sense the worker's hands approaching, it is preferable to dispose it at a predetermined angle to face the front of the chisel insertion hole 32.

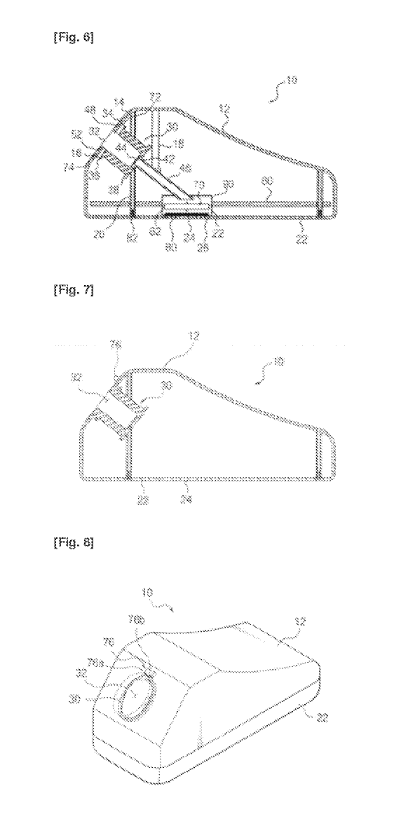

FIG. 8 shows when the optical sensor 76 is composed of a light emitting unit 76 emitting light and a light receiving unit 76b absorbing reflective light and generating a predetermined electric signal, in which the worker's hands can be sensed at the overlap of the light emitting region and the light receiving region, which are indicated by dotted lines. When the chisel insertion hole 32 has a diameter of about 25 mm, it is preferable to set the emission angle at ±20° of the light emitting unit 76a and ±30° of the light receiving unit 76b such that the available sensing distance is about 100 mm.

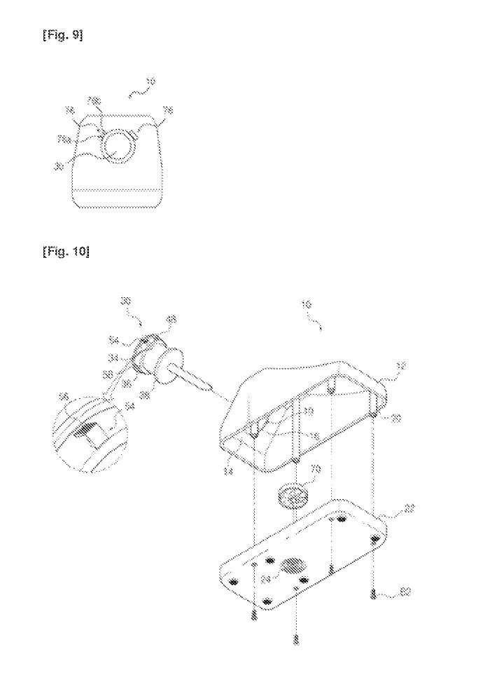

Two optical sensors 76 may be disposed at a predetermined angle (e.g. 120°) around the bobbin 30, as shown in FIG. 9, to increase sensing performance. Obviously, more optical sensors 76 may be disposed.

Meanwhile, the optical sensor 76 may make an error due to lighting or sunlight. In order to prevent the error in the present invention, the light emitting unit 76a emits light in a period of hundreds of msec and the light receiving unit 76a determines whether the worker approaches, by using the emission period.

That is, the light transmitted to the light receiving unit 76b includes the pulse corresponding to the emission period of the light emitting unit 76a, when the light emitting unit 76a emits light in a period larger than the interior lighting or the sunlight, even if the light receiving unit 76b continuously receives the interior lighting or the sunlight. Therefore, it is determined that a worker approaches, when a pulse repeated above a predetermined number of time is sensed by sensing the pulse period of the light received by the light receiving unit 76b.

### Second Embodiment

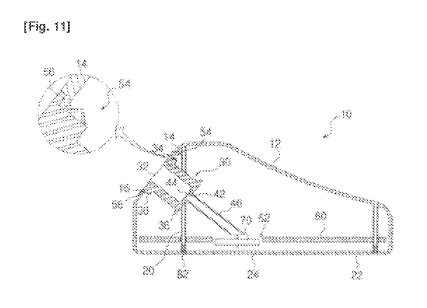

FIGS. 10 and 11 are an exploded perspective view and a combination cross-sectional view of the bottom of an inductive heater according to a second embodiment of the present invention, respectively.

An inductive heater 10 according to the second embodiment of the present invention is characterized by not using bolts to fix the bobbin 30 to the upper case 12, such that it is possible to very simply mount the bobbin 30, as compared with the first embodiment. That is, as shown in FIGS. 2 to 5, the fastening portion 40 at the lower end of the bobbin 30 and the bobbin fixing protrusion 20 corresponding to the fastening portion 40 are removed.

For this configuration, the bobbin 30 according to the second embodiment of the present invention has at least one anti-rotation protrusion 58 and at least one fitting protrusion 54 on the outer side close to the flange 34.

The fitting protrusion 54 prevents the bobbin 30 inserted in the mounting hole 16 from separating and the anti-rotation protrusion 58 prevents the bobbin 30 from rotating, which are preferably symmetrically disposed at two positions, respectively.

Insertion grooves 19 where the anti-rotation protrusions 58 are inserted are formed around the edge of the mounting hole 16 of the upper case 12.

The fitting protrusion 54 a triangular bridge shape that has one end attached to the flange 34 or the outer circumference close to the flange 34 of the bobbin 30, and inclines upward away from the flange 34 and declines. A concave-convexo portion 56 having teeth is formed on the outer side of the fitting protrusion 54 which inclines away from the flange 34 to prevent the bobbin 30 from separating by being engaged with the edge of the mounting hole 16 in the upper case 12.

Therefore, as the anti-rotation protrusions 58 of the bobbin 30 are partially inserted into the insertion grooves and then the bobbin 30 is strongly pushed into the mounting hole 16, the edge of the mounting hole 16 is fitted and fixed between the flange 34 and the fitting groove 54 by elasticity, such that it is not easily pulled out by the fitting protrusion 54 and the concave-convexo portion 56.

Obviously, it is possible to use the anti-rotation protrusions 58, the insertion groove 19, and the fitting protrusion 54 with the fastening portion 40 and the bobbin fixing protrusion 18 of the first embodiment.

Further, though not shown in detail, the inductive heater 10 according to the second embodiment, as described above, may be provided with at least one of the sensor coil wound on the outer circumference of the bobbin 30, the optical sensor 72, 74 in the bobbin 30, and the optical sensor 76 on the outer side of the upper case 12.

Further, the exhaust pipe 46 for discharging wax vapor produced in the chisel insertion hole 32 may be formed or the exhaust fan 70 may be disposed at the bottom of the bobbin 30.

The above description is just some examples of the inductive heater 10 and the detailed shape and configuration of the inductive heater 10 according to the preset invention may be modified in various ways, if needed.

However, the modifications should be construed as being included in the present invention, when being within the scope of the present invention, and the scope of the present invention may be easily understood from the following claims by those skilled in the art.

1. An inductive heater for dental technique, comprising:
a bobbin having a chisel insertion hole open at one end and having a fastening portion protruding outward at the other end;
an induction coil wound around the bobbin;
an upper case having a mounting hole where the bobbin is inserted, and a bobbing fixing protrusion thread-fastened to the fastening portion of the bobbin; and
a lower case connected to the bottom of the upper case.

2. The inductive heater for dental technique according to claim 1, wherein the end of the fastening portion of the bobbin and the end of the bobbin fixing protrusion are in surface contact with each other, when the bobbin is inserted in the mounting hole.

3. An inductive heater for dental technique, comprising:
a bobbin having a chisel insertion hole open at one end, and fitting protrusions with tooth-shaped concave-convexo portion and anti-rotation protrusions on the outer circumference;
an induction coil wound on the bobbin;
an upper case having a mounting hole where the bobbin is inserted and insertion groove formed around the mounting hole to fit the anti-rotation protrusions; and
a lower case connected to the bottom of the upper case,
wherein when the bobbin is inserted in the mounting hole, the concave-convexo portions of the fitting protrusions are engaged with the inner edges of the mounting hole, such that the bobbin is fixed to the upper case.

4. The inductive heater for dental technique according to claim 3, wherein the fitting protrusion has a triangular bridge shape and only the front end of the fitting protrusion is connected to the outer side of the bobbin.

5. The inductive heater for dental technique according to claim 1, wherein at least one optical sensor is disposed inside the chisel insertion hole to sense a chisel that is inserted.

6. The inductive heater for dental technique according to claim 1, wherein at least one optical sensor that senses worker's hands approaching is disposed on the outer side of the upper case or at the front end of the bobbin.

7. The inductive heater for dental technique according to claim 1, further comprising:
a first exhaust hole formed through the bottom of the chisel insertion hole of the bobbin;
a second exhaust hole formed through the upper case or the lower case; and
an exhaust fan disposed around the second exhaust hole.

8. The inductive heater for dental technique according to claim 7, further comprising an exhaust pipe communicating with the first exhaust hole and having one end connected to the end of the bobbin and the other end positioned close to the exhaust fan.

9. An inductive heater for dental technique, comprising:
a bobbin having a chisel insertion hole open at one end and an induction coil wound around the outer circumference;
a case having a mounting hole where the bobbin is inserted;
a first exhaust hole formed at the bottom of the chisel insertion hole of the bobbin;
a second exhaust hole formed through the upper case;
an exhaust fan disposed around the second exhaust hole; and
a filter disposed between the exhaust fan and the second exhaust hole.

10. The inductive heater for dental technique according to claim 9, further comprising:
a through-hole formed through the case; and
a filter cover having the second exhaust hole and separably disposed in the through-hole.

11. The inductive heater for dental technique according to claim 10, further comprising a shield disposed in the case to accommodate the exhaust fan and the filter,
a component communicating with the first exhaust hole and having an end connected with the end of the bobbin and the other end communicating with the inside of the shield.

12. An inductive heater for dental technique, comprising:
a bobbin having a chisel insertion hole open at one end and an induction coil wound around the outer circumference;
a case having a mounting hole where the bobbin is inserted; and
an optical sensor disposed on the outer side of the upper case or at the front end of the bobbin and having a light emitting unit and a light receiving unit for sensing worker's hands approaching.

13. A method of operating an inductive heater for dental technique according to claim 12, comprising:
(a) setting an emission period of the light emitting unit;
(b) making the light emitting unit emit light in the emission period;
(c) determining whether a pulse corresponding to the emission period is sensed as much as a predetermined number of time by analyzing intensity of light transmitted to the light receiving unit; and
(d) applying current to the induction coil by determining that worker's hands approach, when the pulse corresponding to the emission period is sensed as much as the predetermined number of time in the step (c).

14. The inductive heater for dental technique according to claim 2, wherein at least one optical sensor is disposed inside the chisel insertion hole to sense a chisel that is inserted.

15. The inductive heater for dental technique according to claim 3, wherein at least one optical sensor is disposed inside the chisel insertion hole to sense a chisel that is inserted.

16. The inductive heater for dental technique according to claim 4, wherein at least one optical sensor is disposed inside the chisel insertion hole to sense a chisel that is inserted.

17. The inductive heater for dental technique according to claim 2, wherein at least one optical sensor that senses worker's hands approaching is disposed on the outer side of the upper case or at the front end of the bobbin.

18. The inductive heater for dental technique according to claim 3, wherein at least one optical sensor that senses worker's hands approaching is disposed on the outer side of the upper case or at the front end of the bobbin.

19. The inductive heater for dental technique according to claim 4, wherein at least one optical sensor that senses worker's hands approaching is disposed on the outer side of the upper case or at the front end of the bobbin.

20. The inductive heater for dental technique according to claim 2, further comprising:
a first exhaust hole formed through the bottom of the chisel insertion hole of the bobbin;
a second exhaust hole formed through the upper case or the lower case; and
an exhaust fan disposed around the second exhaust hole.

21. The inductive heater for dental technique according to claim 21, further comprising an exhaust pipe communicating with the first exhaust hole and having one end connected to the end of the bobbin and the other end positioned close to the exhaust fan.

22. The inductive heater for dental technique according to claim 3, further comprising:
a first exhaust hole formed through the bottom of the chisel insertion hole of the bobbin;
a second exhaust hole formed through the upper case or the lower case; and
an exhaust fan disposed around the second exhaust hole.

23. The inductive heater for dental technique according to claim 22, further comprising an exhaust pipe communicating with the first exhaust hole and having one end connected to the end of the bobbin and the other end positioned close to the exhaust fan.

24. The inductive heater for dental technique according to claim 4, further comprising:
a first exhaust hole formed through the bottom of the chisel insertion hole of the bobbin;
a second exhaust hole formed through the upper case or the lower case; and
an exhaust fan disposed around the second exhaust hole.

25. The inductive heater for dental technique according to claim 24, further comprising an exhaust pipe communicating with the first exhaust hole and having one end connected to the end of the bobbin and the other end positioned close to the exhaust fan.
